(19) United States
(12) Patent Application Publication
(10) Pub. No.: US 2005/0170803 A1
(43) Pub. Date: Aug. 4, 2005

(54) Method for automatically executing a specified function in a portable terminal

(75) Inventor: Jae-Man Jo, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/935,606

(22) Filed: Sep. 7, 2004

(30) Foreign Application Priority Data
Jan. 29, 2004 (KR) 2004-5777

(51) Int. Cl. H04B 1/38

(52) U.S. Cl. 455/234.1

(57) ABSTRACT

Disclosed is a method for automatically executing a specified function in a portable terminal. The method includes setting a positioning or orientation specified by a user among predetermined positionings of the portable terminal corresponding to a function specified by the user among functions that can be set by the user, checking the positioning of the portable terminal, and executing the specified function set corresponding to the positioning of the portable terminal if the positioning of the portable terminal refers to the specified positioning set corresponding to the specified function. According to the method, a user can conveniently set, release or change functions which can be selectively set by the user.

### PRIORITY

This application claims priority to an application entitled “Method for Automatically Executing Specified Function in Portable Terminal” filed in the Korean Industrial Property Office on Jan. 29, 2004 and assigned Serial No. 2004-5777, the contents of which are hereby incorporated by reference.

### BACKGROUND OF THE INVENTION

1. Field of the Invention

The present invention relates generally to a portable terminal, and more particularly to a method for automatically executing a function, which can be selectively set by a user among other functions of the portable terminal.

2. Description of the Related Art

Typically, a portable terminal such as a mobile phone, PDA (Personal Digital Assistant), etc., has diverse functions that a user can selectively set and execute. For example, such a function may include a morning-call function, a ring/vibration selection function, etc. This morning-call function is a function for outputting of an alarm at a time set by a user each day or every day of the week as set by the user, and the ring/vibration selection function is a function for a user's selection of either a ring or a vibration to alert the user to a incoming call.

The portable terminal, as described above, provides a menu system having menu items corresponding to respective functions so that a user can selectively set a function desired by the user among the functions, which the user can selectively set and execute, through the use of a menu. Each of the menu items may have submenu items in accordance with the characteristics of its corresponding function, and each of the submenu items may have further detailed submenu items. Accordingly, the menu system typically has a tree structure.

If a user wants to newly set a desired function, release or change the set function, he/she accesses to a menu in which menu items of a desired function are presented using a button while viewing the menu displayed on a screen of a display device, and then set a desired function, release or change the set function.

For example, in the process of setting a morning-call function, the user accesses a menu to be displayed by pressing a determined menu button, and selects a main menu item, which provides a morning-call function as its submenu item, among main menu items being displayed in the menu. Thus, submenu items of the main menu item, which provides the morning-call function as its submenu item, are displayed on the screen. If the user selects the morning-call function among the displayed submenu items, a morning-call menu for setting, releasing or changing the morning-call function is displayed. The user specifies an interval, time and alert melody for the morning call, and then sets the morning-call function. The morning-call interval may be set, for example, as one among ‘every day’, ‘from Monday to Saturday’, or ‘from Monday to Friday’.

If the user has set the morning-call interval as ‘every day’ and the morning-call time as 6 a.m., the portable terminal outputs a set melody at 6 a.m. Meanwhile, if the user, who uses the set morning-call function, does not want to receive the morning-call service on Sunday, he/she accesses the morning-call menu through the above-described steps according to the menu system, and then changes the morning-call interval, which is set to ‘every day’, to ‘from Monday to Saturday’, or releases the morning-call function. Thereafter, if the user wants to receive the morning-call service at the morning-call interval set previously, he/she again accesses the morning-call menu through the above-described steps according to the menu system, and then changes the morning-call interval, or sets the morning-call function.

As described above, in order for the user to set a function that the user can selectively set and execute, release or change the set function, he/she must pass through the repeated menu selection procedure every time, and this causes inconvenience in use.

### SUMMARY OF THE INVENTION

Accordingly, the present invention has been made to solve the above-mentioned problems occurring in the prior art, and an object of the present invention is to provide a method for automatically executing a specified function in a portable terminal, which enables a user to conveniently set, release or change a function, which can be selectively set by the user.

Another object of the present invention is to provide a method for automatically executing a specified function in a portable terminal, which can conveniently execute the function, which can be selectively set by the user without using a menu system.

Still another object of the present invention is to provide a method for automatically executing a specified function, which can be selectively set by the user in a portable terminal in accordance with the positioning of the portable terminal.

In order to accomplish this object, there is provided a method for automatically executing a specified function in a portable terminal having a sensor for sensing movement, which includes setting a positioning specified by a user among predetermined positionings of the portable terminal corresponding to a function specified by the user among functions that can be set by the user, checking the positioning of the portable terminal, and executing the specified function set corresponding to the positioning of the portable terminal if the positioning of the portable terminal refers to the specified positioning set corresponding to the specified function. The method may further include ending the execution of the specified function if the positioning of the portable terminal is changed to another positioning after the execution of the specified function.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a portable terminal according to an embodiment of the present invention;

FIGS. 2A to 2C are perspective views illustrating examples of positionings taken by a portable terminal;

FIG. 3 is a flowchart illustrating a process of setting a specified function corresponding to a positioning of a portable terminal according to an embodiment of the present invention; and

FIG. 4 is a flowchart illustrating a process of executing a specified function corresponding to a positioning of a portable terminal according to an embodiment of the present invention.

### DETAILED DESCRIPTION OF THE PREFERRED EMBODIMENT

Hereinafter, the method for automatically executing a specified function in a portable terminal according to a preferred embodiment of the present invention will be described with reference to the accompanying drawings. In the following description of the present invention, same drawing reference numerals are used for the same elements even in different drawings. Also, a detailed description of known functions and configurations incorporated herein will be omitted when it may make the subject matter of the present invention unclear.

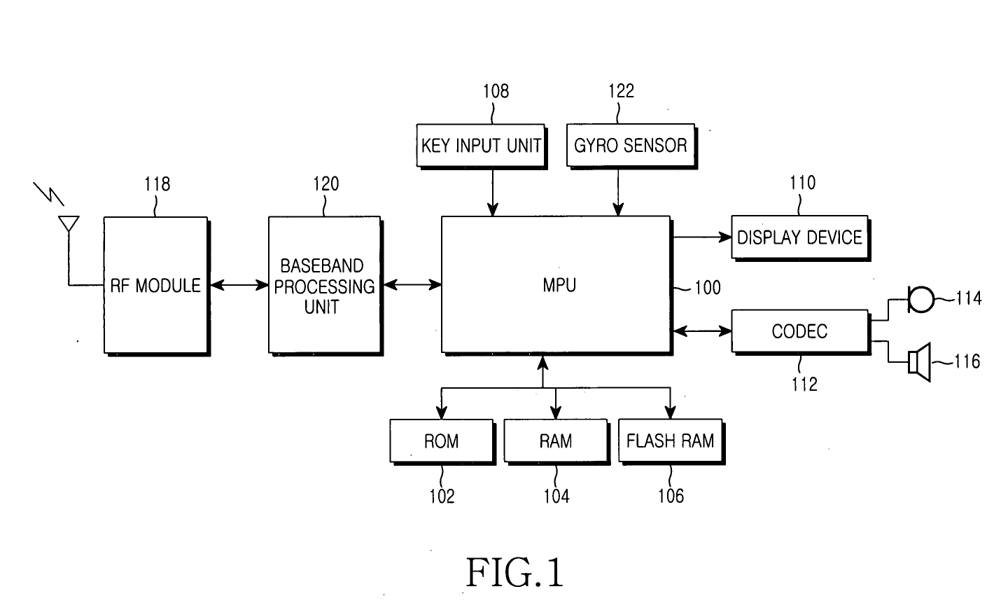

FIG. 1 is a block diagram illustrating the construction of a portable terminal to which the present invention is applied. In FIG. 1, according to the present invention, an MPU (Microprocessor unit) 100 processes and directs typical functions such as a phone call, data communication, etc., and automatically executes a function specified by a user in accordance with a positioning of a portable terminal. ROM (Read Only Memory) 102 stores a micro-code of a program for the MPU's process and control and various kinds of reference data. RAM (Random Access Memory) 104 is provided as a working memory of the MPU 100. A flash RAM 106 provides an area for storing various kinds of data that can be updated. A key input unit 108 includes numeral keys for inputting numerals of 0 to 9 and function keys for setting functions including menu, selection, call, delete, power on/off, *, #, volume, etc., and provides key input data corresponding to the key pressed by a user to the MPU 100.

A display unit 110 displays image information according to the control of the MPU 100 on a screen. A codec (i.e., coder-decoder) 112 connected to the MPU 100, and a microphone 114 and a speaker 116 connected to the codec 112 are used for a call communication and voice recording. An RF (Radio Frequency) module 118 transmits/receives a radio signal to/from a mobile communication base station through an antenna. That is, a signal inputted from the MPU 100 through a baseband processing unit 120 is modulated to an RF signal, and the RF signal is transmitted through the antenna, while the RF signal received through the antenna is demodulated, and the demodulated signal is provided to the MPU 100 through the baseband processing unit 120. The baseband processing unit 120 processes a baseband signal transmitted/received between the RF module 118 and the MPU 100. A gyro sensor 122, which is a sensor for sensing movement, senses movement of the portable terminal, and provides the sensed signal to the MPU 100.

In the embodiment of the present invention, the MPU 100 automatically executes, in accordance with the positioning or orientation of the portable terminal, a function specified by the user in order to selectively set, release or change functions of the portable terminal, which can be set by a user, such as the above-described morning-call function, ring/vibration selection function, etc., in accordance with predetermined positionings of the portable terminal. For this, the user specifies functions desired to be executed in accordance with determined positionings of the portable terminal, and the corresponding positionings of the portable terminal. As examples of specified functions set and executed corresponding to determined positionings of the portable terminal, a morning-call temporary release function related to a morning-call function and a vibration-mode automatic switchover function related to a ring/vibration selection function will be explained hereinafter. The morning-call temporary release function is a function to temporarily release the morning-call function in a state in which the morning-call function is set, and the vibration-mode automatic switchover function is a function to switch a ring mode to a vibration mode in a state in which the ring mode is set for a incoming call alert.

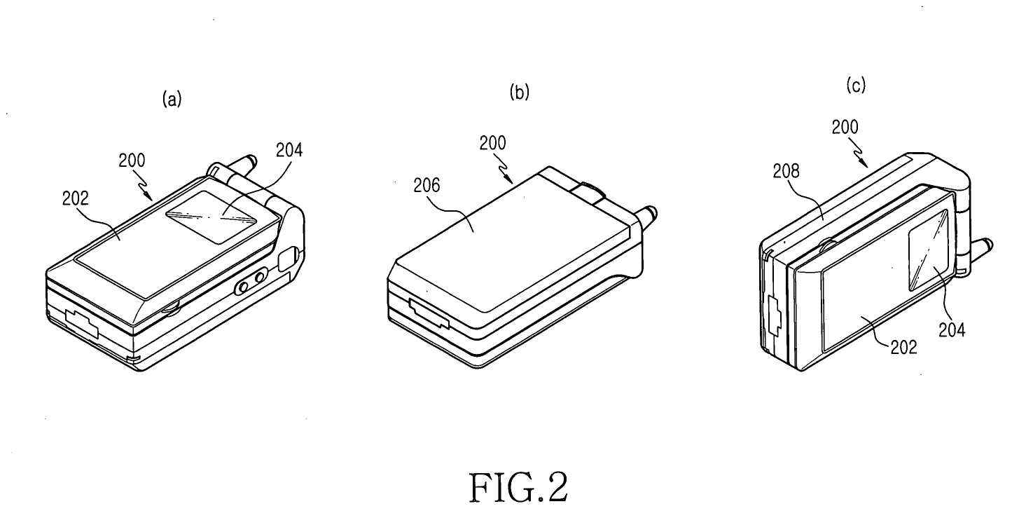

The MPU 100 checks the positioning of the portable terminal based on the movement of the portable terminal sensed by the gyro sensor 122. As shown in FIGS. 2A to 2C, the portable terminal 200 may take several positionings. FIG. 2A shows the positioning of the portable terminal 200, the front part 202 of which faces upward from the ground, FIG. 2B shows the positioning of the portable terminal 200, the rear part 206 of which faces upward from the ground, and FIG. 2C shows the positioning of the portable terminal 200, the side part 208 of which faces upward from the ground. The portable terminal can take other positions, e.g., the second long side, the top and the bottom short edges, as well as each corner of the portable terminal can face up from the ground. Although the portable terminal may take other positionings in addition to the positionings as shown in FIGS. 2A to 2C, it is assumed, for the purpose of the present example, that the MPU 100 recognizes only three positionings as shown in FIGS. 2A to 2C.

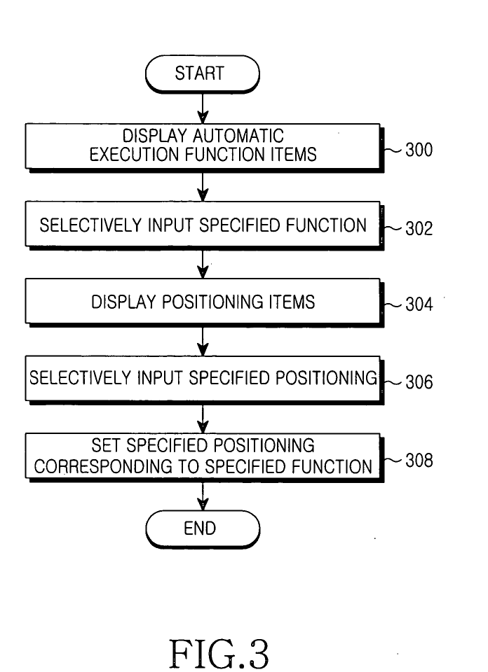

Hereinafter, a process of setting a specified function corresponding to a positioning of a portable terminal according to an embodiment of the present invention will be explained with reference to FIG. 3. If a user selects an automatic execution function setting menu through the key input unit 108, the MPU 100 displays automatic execution function items through the display device 110 at step 300. This automatic execution function setting menu is a menu added to the existing menu system according to the embodiment of the present invention. In this menu, a desired function among functions, which can be set by the user, can be set as an automatic execution function corresponding to any one positioning among the positionings of the portable terminal as shown in FIGS. 2A to 2C, or the automatic execution function as set above can be released. The automatic execution function items are menu items, which indicate the morning-call temporary release function, vibration-mode automatic switchover function, etc. If the user selects the automatic execution function desired by the user among the automatic execution function items being displayed at step 300, the MPU 100 inputs the automatic execution function selected by the user as the specified function at step 302.

Next, the MPU 100 displays positioning items through the display unit 110 at step 304. The positioning items are menu items, which indicate for example the three positionings as shown in FIGS. 2A to 2C. If the user selects the positioning desired by the user among the positioning items being displayed at step 304 through the key input unit 108, the MPU 100 inputs the positioning selected by the user at step 306 as the specified positioning.

After the specified function and the specified positioning are inputted as described above, the MPU 100 sets the specified positioning corresponding to the specified function at step 308, and stores the set information in the flash RAM 106. Accordingly, when the portable terminal takes the positioning desired by the user, the corresponding function that the user desires to execute is set. By repeating the setting process through steps 300 to 308, the user can set another specified positioning corresponding to another specified function, or several specified functions corresponding to one specified positioning.

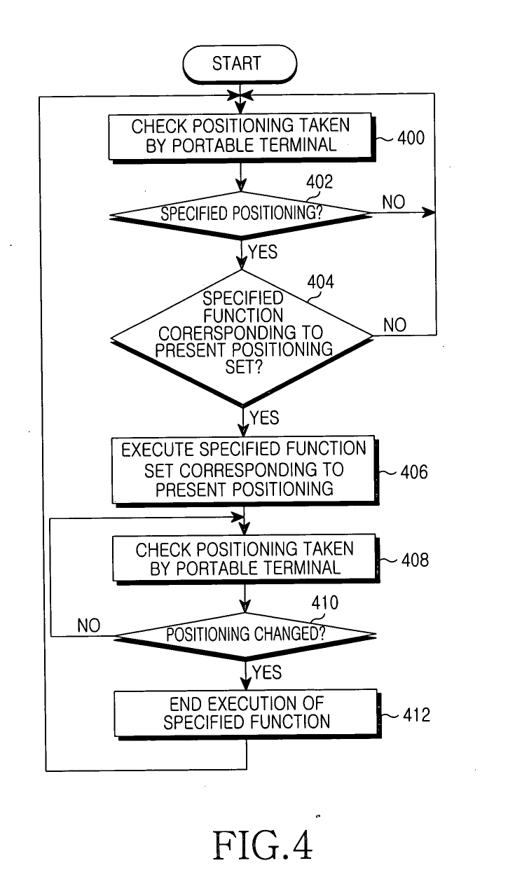

Now, a process of executing a specified function corresponding to a positioning of a portable terminal according to an embodiment of the present invention will be explained with reference to FIG. 4. The MPU 100 checks the positioning or orientation of the portable terminal based on the movement of the portable terminal sensed by the gyro sensor 122 at step 400, and confirms if the positioning taken by the portable terminal refers to any one of the positionings as shown in FIGS. 2A to 2C at step 402. In this case, as the MPU 100 continuously checks the movement of the portable terminal based on the signal generated from the gyro sensor 122 according to the movement of the portable terminal, it confirms whether the orientation of the portable terminal refers to the specified orientation or positioning by comparing the generated signal value with the predetermined values corresponding to the positionings as shown in FIGS. 2A to 2C. In the event that the user who carries the portable terminal moves, the positioning of the portable terminal is continuously changed. Thus, it is preferable that the positioning of the portable terminal is recognized as the specified positioning only in the event that the portable terminal maintains its specified positioning for a predetermined time, for example, for one minute or more. If the positioning taken by the portable terminal does not refer to the specified positioning, the MPU 100 returns to step 400, while if the positioning refers to the specified positioning, at step 404 the MPU 100 checks whether the specified function corresponding to the present positioning is set. If the specified function corresponding to the present positioning is not set, the MPU 100 returns to step 400.

If the specified function corresponding to the present positioning of the portable terminal is set, the MPU 100 executes the specified function set corresponding to the present positioning at step 406. Then, the MPU 100 checks if the positioning of the portable terminal is changed by checking the positioning taken by the portable terminal at steps 408 to 410. If the positioning taken by the portable terminal is changed at step 412, the MPU 100 ends the execution of the specified function, and returns to step 400.

For example, it is assumed that the morning-call function is set in a state in which the morning-call interval is set to ‘every day’ by the user. Also, the positioning of the portable terminal, the rear part of which faces upward, and the morning-call temporary release function are set. If the portable terminal is put face down, i.e., facing the ground, as shown in FIG. 2B, before the morning-call time of the day when the user does not wish to receive the morning-call service, the morning-call temporary release function is executed according to steps 400 to 406, the morning-call function is temporarily released while the portable terminal is put face down, i.e., facing the ground, as shown in FIG. 2B. Thereafter, if the user changes the positioning of the portable terminal, the morning-call temporarily release function being executed is ended according to the steps 408 to 412 the morning-call function, which has been temporarily released, is set again.

For another example, it is assumed that a ring mode is set for a incoming call alert by the user, and the positioning of the portable terminal, the side part of which faces upward and the vibration-mode automatic switchover function are set. If the portable terminal is placed as shown in FIG. 2C while the user attends a meeting, the present mode of the portable terminal is automatically changed to the vibration-mode for the incoming call alert. Thereafter, if the user changes the positioning orientation of the portable terminal, the vibration-mode automatic switchover function being executed is ended according to steps 408 to 412, and the present mode of the portable terminal is changed again to the ring mode.

As described above, according to the present invention, if the user intends to set, release or change the function that can be selectively set and executed by the user, it is enough for the user just to change the positioning or orientation of the portable terminal, and thus inconvenience caused by the repeated menu selecting procedure can be resolved. Also, the power consumption caused by the menu display and key button input for executing the repeated menu selection procedure can be reduced.

In the embodiment of the present invention, the morning-call temporary release function and the vibration-mode automatic switchover function have been described as the specified functions. However, the present invention can be applied to setting, releasing, or changing of other functions of the portable terminal that can be set by the user in the same manner.

While the invention has been shown and described with reference to certain preferred embodiments thereof, it will be understood by those skilled in the art that various changes in form and details may be made therein without departing from the spirit and scope of the invention as defined by the appended claims.

1. A method for automatically executing a specified function in a portable terminal having a sensor for sensing positioning of the portable terminal in relation to the ground, the method comprising the steps of:
setting a positioning specified by a user from among predetermined positionings of the portable terminal to correspond to a function specified by the user from among functions that can be set by the user;
checking the positioning of the portable terminal in relation to the ground; and
executing the specified function set corresponding to the positioning of the portable terminal if the positioning of the portable terminal refers to the specified positioning set corresponding to the specified function.

2. The method as claimed in claim 1, further comprising the step of ending the execution of the specified function if the positioning of the portable terminal is changed to another positioning after the execution of the specified function.

3. The method as claimed in claim 2, further comprising the step of returning the step of checking the positioning of the portable terminal in relation to the ground after ending the execution of the specified function.

4. The method as claimed in claim 1, wherein the positionings of the portable terminal are selected from
a front part of the portable terminal facing upward; and
a rear part of the portable terminal facing upward.

5. The method as claimed in claim 1, wherein the positionings of the portable terminal are selected from
a front part of the portable terminal facing upward;
a rear part of the portable terminal facing upward; and
a first long side part of the portable terminal facing upward.

6. The method as claimed in claim 5, wherein the positionings of the portable terminal are further selected from
a second long side of the portable terminal facing upward;
a top narrow side of the portable terminal facing upward; and
a bottom narrow side of the portable terminal facing upward.

7. The method as claimed in claim 1, wherein the positionings of the portable terminal are selected from
a face of the plurality of faces, the face being a wide surface between four corners, and
a side of the plurality of sides, the side being a narrow surface between four corners,
wherein the portable terminal includes 8 corners, 8 edges, 2 faces and 4 sides.
